(19) United States
(12) Patent Application Publication
(10) Pub. No.: US 2006/0150522 A1
(43) Pub. Date: Jul. 13, 2006

(54) Window sealing and guiding arrangements

(75) Inventor: Domenico Boccuto, Nettetal (DE)

Correspondence Address: LEYDIG VOIT & MAYER, LTD, 700 THIRTEENTH ST. NW, SUITE 300, WASHINGTON, DC, 20005-3960, US

(73) Assignee: GDX North American Inc., Dover, DE (US)

(21) Appl. No.: 10/537,502

(22) PCT Filed: Dec. 1, 2003
(86) PCT No.: PCT/IB03/05622

§ 371 Date: Dec. 22, 2005

(30) Foreign Application Priority Data
Dec. 4, 2002 (GB) 0228290.3
Dec. 31, 2002 (GB) 0230327.9

(51) Int. Cl. E06B 7/16

(52) U.S. Cl. 49/482.1

(57) ABSTRACT

A window frame arrangement, such as for a window opening carried by a vehicle door, is described for use where a stiff window frame is provided with a smoothly radiussed region across a change in direction, such as a corner (14), of the opening. Two separate sealing and guiding strips made of flexible material, each defining a window-glass receiving channel, have respective mitre-cut ends joined together to form a sharp angle at the corner (14) which is outside the smoothly radiussed region of the frame there. One of the sealing and guiding strips comprises extruded material defining a channel (64) which embracingly grips a flange (58) forming part of the window frame. The flexible material defines a small lip (72) positioned for contacting the outside of the window glass (12), and is extended to provide a limb (74) carrying a larger lip (78) for contacting the inside surface of the window glass (12). This limb (74) lies alongside a panel part (54) which is part of the window frame and is secured thereto by an integral projection (82). The flexible material defines a hollow chamber (90) at the end of the limb (74). In the smoothly radiussed region of the window frame, the window frame panel (54) has a correspondingly greater and progressively varying length than elsewhere, and over this region the flexible material is cut through at the wall of the hollow chamber (90) and a separate edge formation part (100) is moulded onto the strip (and also onto the second strip meeting it at the sharp corner), and carries a cosmetic lip (102) which extends over a flange (62) at the edge of the panel (54). Along the remainder of the strip, outside the smoothly radiussed region, the flexible material adjacent the hollow chamber (90) defines an integral cosmetic lip.

### TECHNICAL FIELD

The invention relates to window sealing and guiding arrangements. Embodiments of the invention, to be described in more detail below by way of example only, are in the form of sealing and guiding strips and window frame arrangements for window frames carried by vehicle doors, where the window frame has a change in direction. However, embodiments of the invention can be used for other purposes.

### DISCLOSURE OF INVENTION

According to the invention, there is provided a sealing or guiding strip made of flexible material and for mounting adjacent to a more rigid panel of varying size, the strip having an edge formation arranged to juxtapose with an edge of the panel along a portion of the length of the strip corresponding to a first region of the panel where the panel has a predetermined relatively small extent, the flexible material defining a hollow cavity extending at least along another portion of the length of the strip corresponding to a second region of the panel where the panel has a relatively larger extent, whereby the edge formation can be removed along a cut line extending into the hollow cavity and can be replaced by a separate edge formation part of extended size and which is secured to the strip for juxtaposing with the panel in the second region.

According to the invention, there is further provided a window frame arrangement for a window opening, comprising a stiff window frame having a smoothly radiussed region extending across a change in direction of the window opening, and two sealing and guiding strips made of flexible material each defining a channel for receiving a pane of window glass for the opening and which are secured together at the change in direction, each strip having an integral edge formation extending integrally therealong and arranged to engage with an edge of the window frame along a portion of the length of the strip outside the smoothly radiussed region, the flexible material of each strip defining a hollow cavity extending therealong adjacent to the edge formation, the edge formation having been removed along a cut line which extends into the hollow cavity and which also extends along a portion of the length of the strip corresponding to the smoothly radiussed region and having been replaced by a separate edge formation part secured to both strips for engaging an edge of the window frame in the said region.

### BRIEF DESCRIPTION OF DRAWINGS

Window sealing and guiding strips and window frame arrangements embodying the invention, and for use in windows in motor vehicle bodies, will now be described, by way of example only, with reference to the accompanying diagrammatic drawings in which:

FIG. 1 is a side view of a vehicle door carrying one of the strips;

FIG. 2 is an enlarged view of the area II of FIG. 1;

FIG. 3 is a section on the line IV-IV of FIG. 2;

FIG. 4 is a section on the line III-III of FIG. 2;

FIG. 5 is a section on the line VI-VI of FIG. 2;

FIG. 6 is a section on the line V-V of FIG. 2;

FIGS. 7 and 8 correspond to FIGS. 4 and 6 but show a modification; and

FIG. 9 explains a process of manufacturing the strip portion shown in FIGS. 7 and 8.

### MODES OF CARRYING OUT THE INVENTION

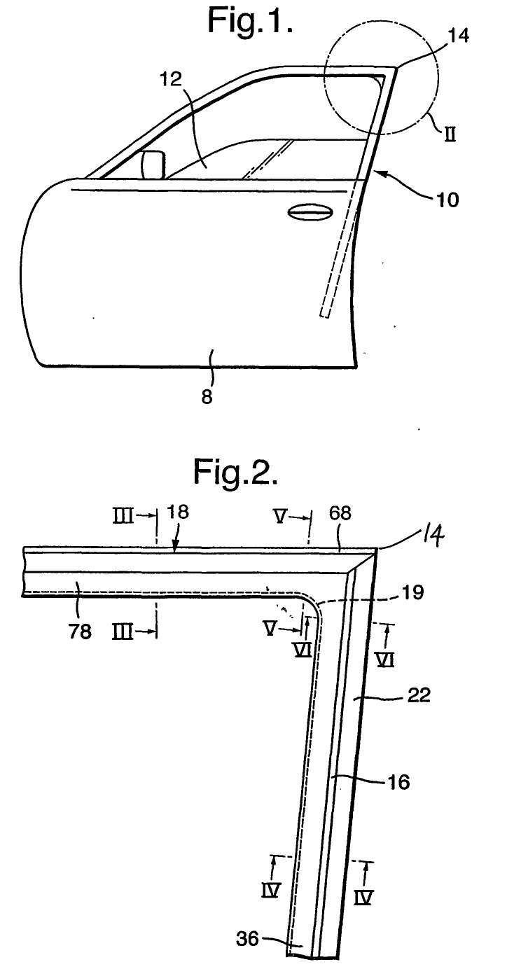

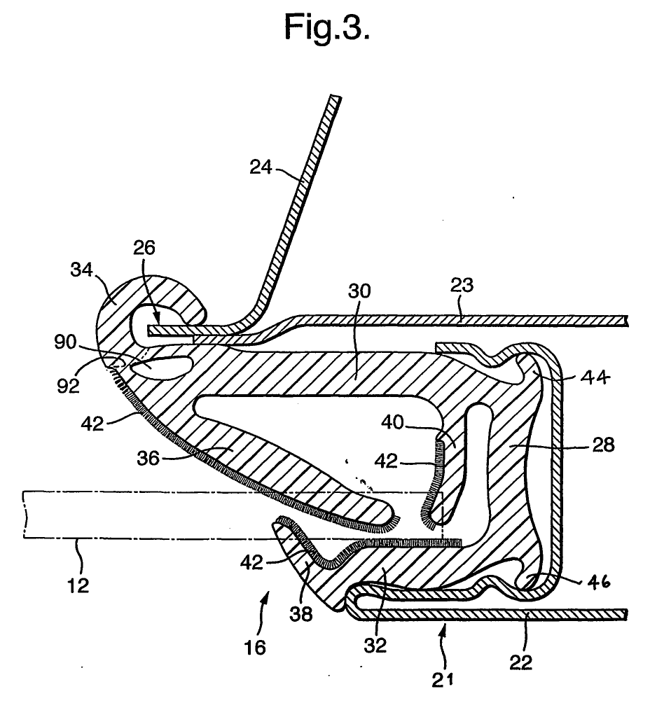

FIG. 1 shows a vehicle door 8 carrying a sealing and guiding channel arrangement 10 in which a pane of window glass 12 is slidable in a vertical direction as it is raised from or lowered into the lower part of the door 8. The sealing and guiding arrangement 10 comprises a window frame and sealing and guiding channels mounted on the frame, as will be described. The sealing and guiding channels define a sharp corner 14 and the construction in the region of the sharp corner is shown in enlarged detail in FIG. 2.

As shown in FIG. 2, along the ‘B’ pillar of the vehicle, the sealing and guiding arrangement 10 comprises a strip portion 16. The strip portion 16 is of channel form to receive the window pane 12 and comprises an outer channel wall 16A (on the outside of the window pane) and an inner channel 16 (on the inside of the window pane).

Along the top of the window frame (and along the ‘A’ pillar of the vehicle), the sealing and guiding channel arrangement 10 comprises a strip portion 18. The strip portion 18 is of also channel form to receive the window pane 12 and comprises an outer channel wall 18A (that is, a channel wall on the outside of the window pane) and an inner channel wall 18B (that is, a channel wall on the inside of the window pane 12).

The two strip portions 16 and 18 are mitre-cut and joined together at the sharp corner 14.

The stiff window frame on which the strip portions 16,18 are mounted is only partly visible in FIGS. 1 and 2. The construction of the window frame, and the manner in which the strip portions 16,18 are mounted on it will be described below.

At the sharp corner 14, the window frame is smoothly radiussed as shown dotted at 19 and this part of the frame is covered over by a flap 20 forming part of the sealing and guiding channel 10 in a manner to be explained.

In a manner to be explained in more detail below, the sealing and guiding strip channel 10 is produced, such as by extrusion, from flexible material such as plastics or rubber. It is designed to provide a weather-proof seal for the edge of the window glass and also to impose low friction on the movement of the glass.

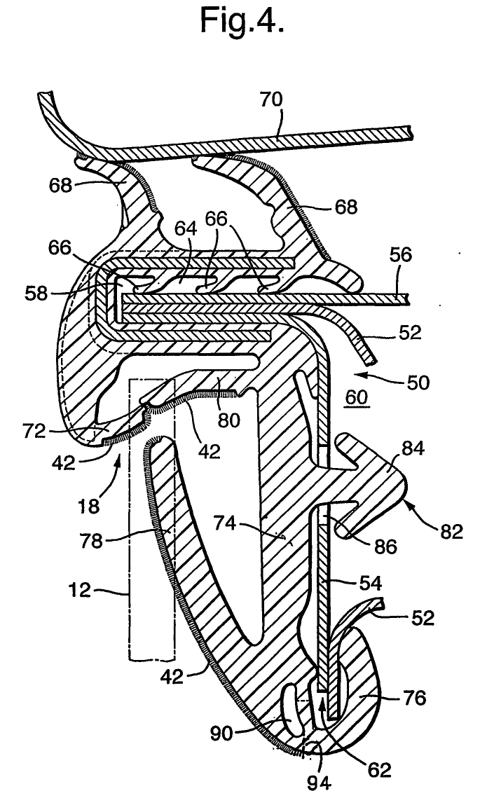

FIG. 3 shows a section on the line IV-IV of FIG. 2, that is, along the ‘B’ pillar. The stiff window frame is shown generally at 21 and comprises a rigid channel formed by bending over the outer panel 22 of the vehicle door and then forming the bent-over portion into channel form. The window frame 21 is completed by the inner panels 23 and 24 of the door which meet to form a flange 26.

The strip portion 16 is made of extruded plastics or rubber material and is of integral channel-form comprising a base 28 and side walls 30 and 32. Along its distal edge, the side wall 30 extends in one direction to form a lip (a “cosmetic lip”) 34 which covers over the edge of the flange 26 and extends in the other direction to form a longer and more flexible lip 36 which extends partway across the mouth of the channel. The distal edge of the wall 32 is extended to form a short flexible lip 38. Adjacent the base 28 of the channel is a further lip 40. The window pane 12 is guided within the channel as it slides in a vertical direction by the lips 36,38 and 40. The surfaces of these lips making contact with the window glass 12 are advantageously covered with layers of flock 42, or another suitable low-friction coating.

The outside of the base 28 of the portion 16 has short outwardly extending lips 44,46 which help to secure the strip portion 16 within the channel of the window frame 21.

Different parts of the strip portion 16 may have different hardnesses.

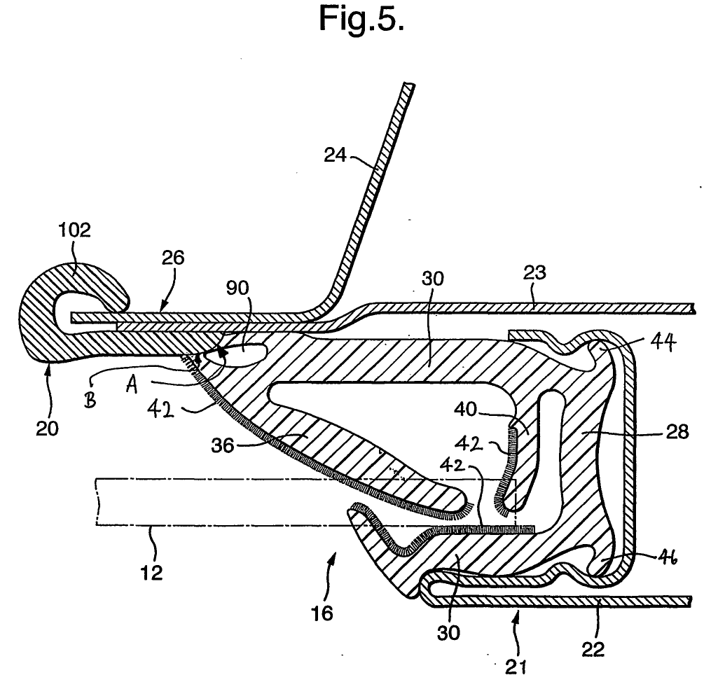

FIG. 4 is a cross-section on the line III-III of FIG. 2. Here, the window frame shown generally at 50 is formed by panels 52,54 and 56 of the door which are joined together to form, a flange 58 projecting outwardly of the door. The panels 52 and 54 diverge from each other in the direction away from the flange 58 to form a hollow space 60 and then come together again to form a further flange 62 where they are again joined together.

The strip portion 18 is again extruded integrally from plastics or rubber material and defines a channel 64 which embraces the flange 58 to hold the strip portion 18 in position. The extruded material may carry integral inwardly extending lips 66 to assist in securing the sealing and guiding strip in position on the flange and a reinforcing carrier 67 may be embedded in the extruded material. The reinforcing carrier 67 may be formed from any suitable relatively rigid material, such as metal or plastics.

The extruded material of the strip portion on one outside wall of the channel 64 carries large flexible sealing lips 68 which, when the vehicle door 8 is closed, seal against the roof line 70 of the vehicle.

The material on the outside of the base of the channel 64 carries a re-entrant lip 72. The material adjacent the mouth of the channel 58 is extended to form a limb 74 which lies against the door panel 54 and terminates in a lip (a “cosmetic lip”) 76 which embraces the edge of the flange 62. In addition, the distal end of the limb 74 integrally carries a large flexible lip 78 which extends towards the lip 72 so that, together, these lips define the channel for receiving the window pane 12 (shown dotted). A further lip 80 extends partway across the base of this channel.

The surfaces of the lips 72,78 and 80 which make contact with the window pane 12 may carry layers of flock 42, or another suitable low-friction coating.

The limb 74 is further clamped to the window frame by means of a resiliently deformable protrusion 82 having an enlarged head portion 84 which is pushed through an aperture 86 in the panel 54 and into the hollow space 60. After passing through the aperture 86, the enlarged head 84 resiles and presses against the panel 54 around the edges of the aperture 86.

It will be noted that the extruded plastics or rubber material of the strip portion 16 of FIG. 3 is provided with a longitudinally extending hollow cavity or chamber 90 located near the distal edge of the channel side wall 30. A similar longitudinally extending hollow chamber 90 is provided in the material of the strip portion 18 shown in FIG. 4, this hollow chamber being located at the distal end of the limb 74.

As explained in connection with FIG. 2, the window frame 12 includes a portion 19 (shown dotted) which smoothly bridges across the sharp corner. In other words, the door panels 23,24 (FIG. 3) are progressively extended in length (in the direction towards the centre of the window opening), in the immediate vicinity of the sharp angle 14, this increase in length being progressively greater in the direction up the “B” pillar towards the sharp corner 16. Similarly, the lengths of the door panels 52 and 54 (FIG. 4) progressively increase in the direction along the roof line towards the sharp corner 16.

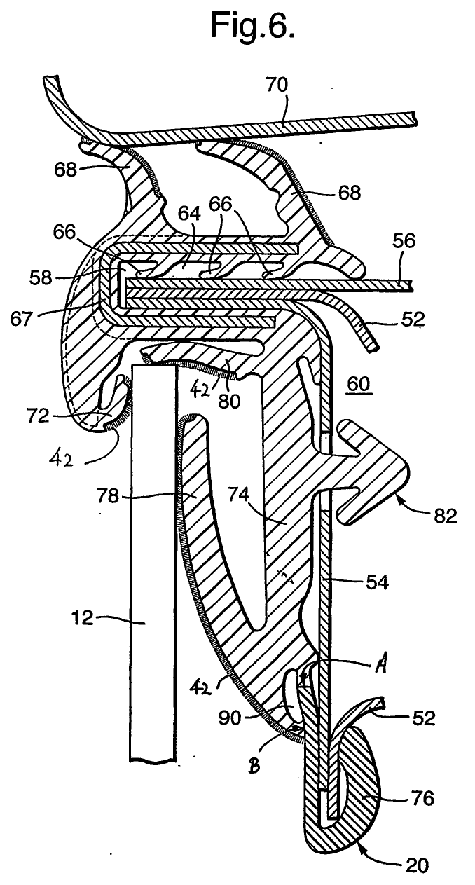

FIG. 5 shows a section on the line VI-VI of FIG. 2, the section plane being closer to the sharp corner 16 than the section plane IV-IV of FIG. 3. FIG. 5 shows that the general shape of the window frame and the strip portion 16 is similar to that shown in FIG. 3, except that the panels 22 and 24 have increased length.

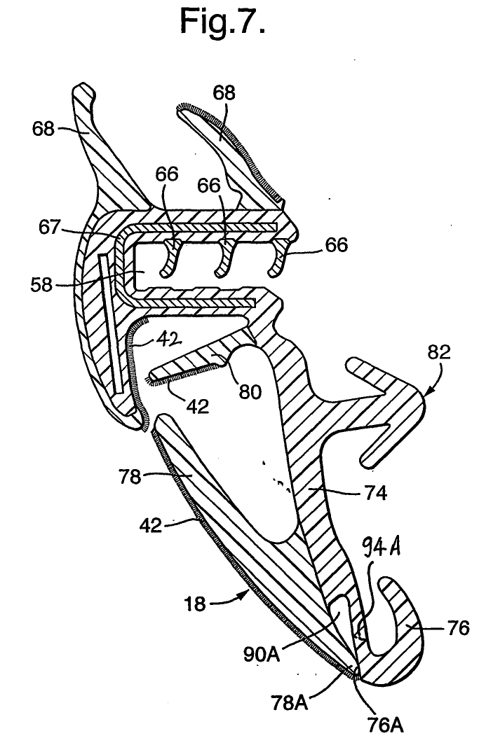

Similarly, FIG. 6 is a section on the line V-V of FIG. 2, the section plane being closer to the sharp angle 16 than the section plane III-III shown in FIG. 4. Here, again, the configuration of the window frame and of the strip portion 18 is generally the same as is shown in FIG. 4, except for the extended lengths of the panels 52 and 54.

As explained above, in constructing the sealing and guiding channel 10 for the window opening, separate sealing and guiding strip portions 16,18, respectively having the configurations shown in FIGS. 3 and 4, are extruded and one end of each such strip is mitre-cut and the two cut ends are brought together and joined at the sharp angle 14. However, because of the extended lengths of the panels 23 and 24 (as shown in FIG. 5) and 52 and 54 (as shown in FIG. 6), it is necessary to modify the configuration of the sealing and guiding strip portions 16,18 in the region of the sharp angle 14.

As shown in FIG. 5, this is achieved (for the strip portion 16) by cutting through the extruded material along the dotted line shown at 92 (in FIG. 3) adjacent to the wall of the hollow chamber 90, so as to remove the cosmetic lip 34. Similarly, and as shown in FIG. 6, a cut is made through the extruded material along the dotted line shown at 94 (in FIG. 4) immediately adjacent the hollow chamber 90, so as to remove the cosmetic lip 76. These cutting actions take place, of course, only over those parts of the lengths of the strip portions 16,18 adjacent the sharp corner 14, where the lengths of the panels forming the respective window frame portions have been extended.

It should be understood that the cut may be made in a different position to that shown at 92 or 94.

After the cosmetic lips 34 and 76 have been removed in this way, the two ends of the sealing and guiding strip portions 16,18 are brought together (after having been mitre-cut) in a mould. The moulding operation not only joins the mitre-cut ends together but also moulds the extended flap 20 (see FIGS. 5 and 6), carrying a cosmetic lip 102, into position on both strip portions 16,18. This flap 20 becomes joined to the sealing and guiding strip portions 16,18 along (only) regions A of the cutting lines 92 (FIG. 5) and 94 (FIG. 6). It is preferred in this embodiment to mould the flap 20 to the sealing and guiding strip portions 16,18 only along region A because this avoids having to subject the flock 42 in regions B to the heat and pressure required for the moulding operation. This reduces or prevents damage to the flock 42, so that the flock 42 will have a neat and attractive appearance, the flock extending completely up to the point where the flap 20 abuts the lip 78.

It is possible to mould the flap 20 to the sealing and guiding strip portions 16,18 additionally (or alternatively) along regions B of the cutting lines 92 (FIG. 5) and 94 (FIG. 6). If, however, the flap 20 is moulded to the sealing and guiding strip portions 16,18 at regions B, then it may be advantageous to not apply flock 42 to the surface of the lip 78 near the region B, but instead to leave a non-flocked surface area between the flock 42 and the region B. Flock applied to this area may be damaged by the moulding process and might have an unattractive appearance, and there may not be a visually distinct line at the point where the flap 20 meets the lip 78.

The cosmetic lip 102 carried by the moulded-on flap 20 embraces the flange produced where the ends of the extended panels 23,26 (FIG. 5) meet and where the extended panels 52,54 (FIG. 6) meet.

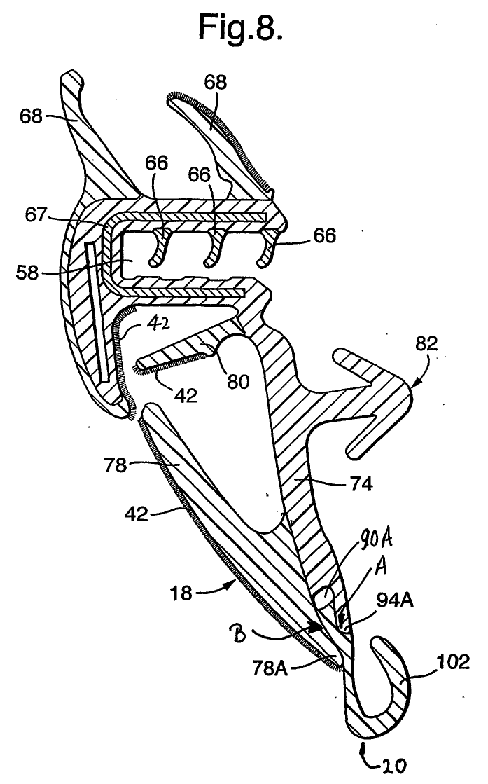

FIGS. 7 and 8 correspond generally to FIGS. 4 and 6 except that the window frame on which the strip portion 18 is mounted is not shown in FIGS. 7 and 8. Parts in FIGS. 7 and 8 corresponding to parts in FIGS. 4 and 6 are similarly referenced.

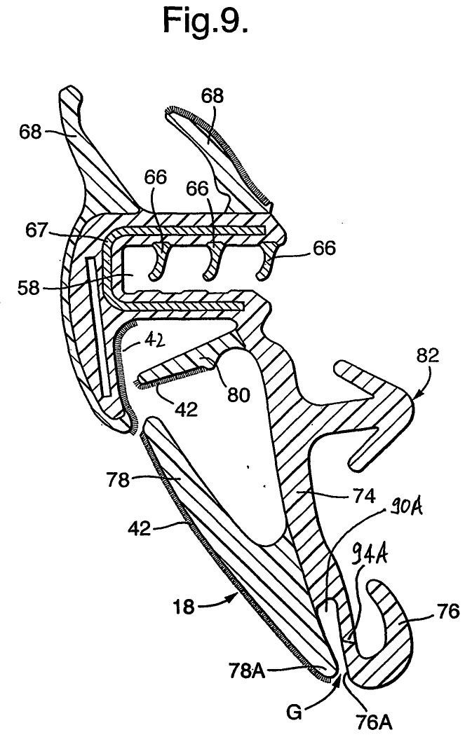

In FIGS. 7 and 8, the hollow chamber 90 is not formed within the extruded material but is replaced by a hollow cavity 90A. The large flexible lip 78 has a “foot” 78A which is produced by the extrusion process so as to be separate from the extruded material of the cosmetic lip 76. FIG. 9 (showing part, only, of FIG. 7) shows the relative positioning of the distal edge of the foot 78A and the adjacent surface 76A of the cosmetic lip 76 at the exit of the extruder and shows a gap ‘G’ between them. However, at the exit of the extruder, a suitable roller arrangement is provided which forces the distal edge 78A of the foot 78 into firm contact with the surface 76A of the cosmetic lip 76. Because the material has only just emerged from the extruder, the two parts which are pressed firmly together by the roller arrangement become adhered to each other (for example, by the cross-linking process which continues after extrusion), thereby forming the cavity 90A. In this way, therefore, no unsightly gap is visible to an observer viewing into the channel which receives the window pane. As an alternative to pressing the two parts together and causing them to adhere or stick to one another, the parts may be pressed together so that they abut one another but are not adhered together.

In the region of the sharp angle 14, the smoothly radiussed part 19 of the window frame (see FIG. 2) is covered over by a flap 20 as explained. As shown in FIG. 8, therefore, a cut is made along a line 94A to separate the material of the foot 78A of the lip 78 from the material of the cosmetic lip 76 and the cosmetic lip 76 is removed. Then, a moulding operation is carried out to produce the extended flap 20 carrying the cosmetic lip 102 which thus embraces the ends of the extended panels 52, 54 (FIG. 6, but not shown in FIG. 8).

In FIG. 8 the flap 20 is shown partially filling the hollow cavity 90A. It should be understood that the material of the flap 20 could completely fill the hollow cavity 90A, so that there is no void.

The region A where the flap 20 is moulded onto the material of the window channel is not externally visible, being hidden behind the distal edge of the foot 78A. The flap 20 may be only moulded onto the window channel at region A, or it may additionally (or alternatively) be moulded onto the window channel at region B, where the distal edge 78A of the foot 78 meets the flap 20.

Advantageously, in this embodiment, the flap 20 is made from TPE, instead of conventional EPDM. TPE can be formed and moulded onto other components at a lower mould temperature than is required for EPDM. The moulding process for the TPE flap is therefore less likely to damage the flock 42 at the distal edge 78A of the foot 78.

However, it should be understood that the flap 20 could be formed of EPDM (or any other suitable material). If the flap 20 is formed of EPDM and is moulded onto the window channel at region B, then it may be preferred to not apply flock 42 to the distal edge 78A of the foot 78, because flock at this region may be damaged by the heat of the moulding operation and may have an unattractive appearance.

The use of TPE is also advantageous because it can be recycled relatively easily.

Along the B pillar of the window frame, the strip portion 16 (FIGS. 3 and 5) may be modified in the same way as described with reference to FIGS. 7, 8 and 9, to produce a cavity 90A instead of the cavity or chamber 90. The moulding operation can thus be arranged to join the strip portions 16 and 18 together and to mould the extended flap 20, carrying the cosmetic lip 102, onto both strip portions where they meet at the corner of the window frame.

Although the foregoing description has illustrated the construction in the region of a sharp corner 14, the same general form of construction can be used in cases where there is no sharp corner but some other form of change of direction such as a corner with a less sharp angle or a curve or bend, for example where the A or C pillar meets the roof.

1. A sealing or guiding strip made of flexible material and for mounting adjacent to a more rigid panel having an edge with a first region where the panel has a predetermined relatively small extend and a second region where the panel has a relatively large extent, the strip, and an edge formation arranged to juxtapose with the edge of the panel along a portion of the length of the strip corresponding to the first region of the panel, the flexible material of the strip defining a hollow cavity extending at least along another portion of the length of the strip corresponding to a second region of the panel, a cut line extending into the hollow cavity whereby the edge formation can be removed along the cut line and can be replaced by a separate edge formation part of extended size and which is secured to the strip for juxtaposing with the panel in the second region.

2. The strip according to claim 1, wherein the cavity is a hollow chamber formed within the flexible material.

3. The strip according to claim 2, wherein the strip produced by an extrusion process which also produces the hollow chamber.

4. The strip according to claim 1, produced using an extrusion process and in which the hollow cavity is produced by pressing together two parts of the material immediately after the extrusion process so that they become secured together during the subsequent processing but leaving between them the hollow cavity.

5. The strip according to claim 1, wherein the second region of the panel progressively changes in size and the separate edge formation correspondingly changes in size.

6. The strip according to claim 1, further comprising a channel for receiving a pane of window glass for a window opening, and in which the panel is part of a rigid frame for the window opening.

7. The strip according to claim 1, wherein the separate edge formation is secured to the strip along the said cut line.

8. The strip according to claim 1, wherein the separate edge formation is a molded structure.

9. The strip according to claim 8, wherein the separate edge formation is molded to the strip.

10. The strip according to claim 1, wherein the hollow cavity extends along the whole length of the strip.

11. The strip according to claim 1, secured to a second strip.

12. The strip according to claim 11, secured to the second strip by a molding operation.

13. The strip according to claim 12, wherein the molding operation which secures the strip to the second strip and the separate edge formation.

14. The strip according to claim 1, further comprising a channel for receiving a pane of window glass for a predetermined window opening, the said panel forming part of a frame for the window opening and the second region being a region adjacent a change in direction of the window frame.

15. The strip according to claim 14, in combination with a second strip which also defines a channel for receiving the pane of window glass, the two strips being secured together at the change in direction of the window frame.

16. The strip according to claim 15, wherein the separate edge formation is also secured to the second strip.

17. The strip according to claims 1, wherein the edge formation comprises TPE.

18. A window frame arrangement for a window opening, comprising a stiff window frame having an edge and a smoothly radiused region extending across a change in direction of the window opening, and two sealing and guiding strips made of flexible material, each said strip having a length and defining a channel for receiving a pane of window glass for the opening and which are secured together at the change in direction, each said strip having an integral edge formation extending integrally therealong and arranged to engage with the edge of the window frame along a portion of the length of the strip outside the smoothly radiused region, the flexible material of each strip defining a hollow cavity extending therealong adjacent to the edge formation, the edge formation having been removed along a cut line which extends into the hollow cavity and which also extends along a portion of a the length of the strip corresponding to the smoothly radiussed region and having been replaced by a separate edge formation part secured to both strips for engaging the edge of the window frame in the said region.

19. The arrangement according to claim 18, wherein the cavity in each strip is a hollow chamber formed within the flexible material.

20. The arrangement according to claim 19, produced by an extrusion process which also produces the hollow chamber.

21. The arrangement according to claim 18, produced using an extrusion process, the hollow cavity is being produced by pressing together two parts of the material immediately after the extrusion process so that the two parts become secured together during subsequent processing.

22. The arrangement according to claim 18, wherein the separate edge formation is secured to the strips along at least part of the said cut lines of each of them.

23. The arrangement according to claim 18, wherein the strips are secured together by a molding operation which also secures the separate edge formation to the strips.

24. The arrangement according to claim 23, wherein the separate edge formation is produced by the molding operation.

25. The arrangement according to claim 18, wherein the integral edge formation and the separate edge formation each comprise a cosmetic lip.

26. The arrangement according to claim 18 wherein the change in direction of the window opening is a sharp corner of the window frame.

27. The arrangement according to claim 18, wherein the separate edge formation comprises TPE.
